(19) United States
(12) Patent Application Publication
(10) Pub. No.: US 2018/0276614 A1
(43) Pub. Date: Sep. 27, 2018

(54) System for Inventory Control

(71) Applicant: Walmart Apollo, LLC, Bentonville, AR (US)

(72) Inventors: Richard M. Blair, II, Bentonville, AR (US); Steven Lewis, Bentonville, AR (US); Anthony G. Wind, III, Gravette, AR (US)

(73) Assignee: Walmart Apollo, LLC, Bentonville, AR (US)

(21) Appl. No.: 15/933,418

(22) Filed: Mar. 23, 2018

Related U.S. Application Data
(60) Provisional application No. 62/475,283, filed on Mar. 23, 2017.

(51) Int. Cl. G06Q 10/08; G08G 1/14

(52) U.S. Cl. CPC G06Q 10/08355; G08G 1/141; G06Q 10/0834; G06Q 10/0875

(57) ABSTRACT

Systems, methods, and computer-readable storage mediums for transporting inventory are provided to ensure that a retail business can replenish goods fast. An example method can include determining that a first business location requires replenishment of an item and that a second business location has the item. A delivery request is initiated for the item to be delivered from the second business location to the first retail location. The method causes broadcasting a courier opportunity to multiple couriers based on the delivery request and receiving a claim to deliver the item from at least one of the couriers. In response to receiving the claim, a task is assigned to a selected courier. Further, an account of the selected courier is debited when the item is picked up. When a confirmation that the item was delivered is received, the account of the selected courier is credited.

### BACKGROUND

### 1. Technical Field

The present disclosure relates to a cross-store transfer of inventory. More specifically, the present disclosure relates to a system and a method for transporting inventory from one retail location to another using couriers.

### 2. Introduction

Retail businesses conventionally maintain small inventory levels. This approach allows businesses to minimize storage and operational costs. Many businesses calculate estimations of required inventory levels considering market demands, historical data, and other factors. Based on such estimations, the businesses typically purchase or request shipment of certain goods in advance to keep the inventory at predetermined levels.

One problem with this approach arises when there is an unexpected increase in demand of certain goods. It is common that retail businesses sell out some goods quickly without apparent cause. Although the retail businesses need to replenish the sold-out goods fast to meet the market demand, it is not always feasible to do. For example, some goods may need to be delivered from a remote location and it can take days to transfer these goods. In other circumstances, the goods to be replenished must be produced or manufactured which can be yet a longer process. When goods are not replenished when needed, the retail businesses can experience lost revenues, decreased customer satisfaction, or higher operational costs.

### SUMMARY

Disclosed herein are systems, methods, and computer-readable storage mediums for transporting inventory, which overcome at least some drawbacks known in the art. An exemplary method for transporting inventory can include: determining that a first business location requires replenishment of an item; determining that a second business location has the item; initiating a delivery request for the item to be delivered from the second business location to the first retail location; broadcasting a courier opportunity to couriers based on the delivery request; receiving a claim to deliver the item from at least one of the couriers; in response to receiving the claim, assigning a task to a selected courier; debiting an account of the selected courier when the item is picked up by the selected courier; receiving a confirmation that the item was delivered by the selected courier; and in response to the confirmation, crediting the account of the selected courier.

An exemplary system for transporting inventory can include a server maintaining a web service accessible by couriers, wherein the server is configured to: determine that a first business location requires replenishment of an item; determine that a second business location has the item; initiate a delivery request for the item to be delivered from the second business location to the first retail location; broadcast a courier opportunity to couriers based on the delivery request; receive a claim to deliver the item from at least one of the couriers; in response to receiving the claim, assign a task to a selected courier; debit an account of the selected courier when the item is picked up by the selected courier; receive a confirmation that the item was delivered by the selected courier; and in response to the confirmation, credit the account of the selected courier.

An exemplary non-transitory processor-readable storage medium can have instructions stored thereon, which when executed by one or more processors, cause the one or more processors to implement a method for transporting inventory, the method comprising: determining that a first business location requires replenishment of an item; determining that a second business location has the item; initiating a delivery request for the item to be delivered from the second business location to the first retail location; broadcasting a courier opportunity to couriers based on the delivery request; receiving a claim to deliver the item from at least one of the couriers; in response to receiving the claim, assigning a task to a selected courier; debiting an account of the selected courier when the item is picked up by the selected courier; receiving a confirmation that the item was delivered by the selected courier; and in response to the confirmation, crediting the account of the selected courier.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Embodiments of this disclosure are illustrated by way of an example and not limitation in the figures of the accompanying drawings, in which like references indicate similar elements and in which:

FIG. 1 illustrates a simplified geographic map showing a plurality of business locations and a plurality of couriers according to one example embodiment;

FIG. 2A illustrates an example computer system environment for practicing methods for transporting inventory;

FIG. 2B illustrates another example computer system environment for practicing methods for transporting inventory;

FIG. 3 illustrates an exemplary method embodiment; and

FIG. 4 illustrates an example computer system which can be used to implement the methods for transporting inventory.

### DETAILED DESCRIPTION

Various configurations and embodiments of the disclosure are described in detail below. While specific implementations are described, it should be understood that this is done for illustration purposes only. Other components and configurations may be used without parting from the spirit and scope of the disclosure.

The concepts and embodiments described herein are provided to facilitate the replenishment of goods at retail stores or other businesses using the force of one or more couriers. More particularly, this disclosure concerns a system and method for transporting inventory from one location to another location by one or more couriers. The couriers can be independent, “crowd sourced,” and not affiliated with any retail business, but not necessarily. For example, the couriers could be independent contractors, customers, buyers, or other individuals. In other implementations, the couriers could be employees or agents of a shipping company. In other implementations, the couriers could be autonomous vehicles. The system may employ an online platform or a web service which can be accessed by mobile devices of the couriers or by the autonomous vehicles. The system can be configured to select, coordinate, and manage one or more couriers to transport certain inventory items from one business location to another one. The following provides an example process of system operation for transporting inventory.

Initially, the system determines that replenishment of an item is required when a first business location, such as a first retail store, sells out a particular goods item, is close to sell out the item, or is otherwise required to increase an inventory level of the item. This can be determined by receiving a manual input of an operator of the first business location or by automatic checking an inventory database that indicates that the item is sold out or about to be sold out at the first retail store. The system can use predictive modeling to determine when items should be ordered. The system may monitor the current inventory level and consumption rate of the item. Based on this information the system may assign a priority to the replenishment of the item. For example, if there are five of an item in inventory and the retail store is selling one item a month, the item may be assigned a lower priority. In contrast, if there are ten of an item remaining and the store is selling eight a day, the item is assigned a higher priority.

The system further determines if any other business location (for example, within a predetermined distance from the first business location) has the item at quantities sufficient to replenish the inventory level of the item at the first business location. The system may also consider if the transfer of items would leave sufficient items at the other business location. For these ends, the system can search one or more inventory databases associated with one or more business locations. Accordingly, when the system determines that a second business location, such as a second retail store or a warehouse, has the item, the system can initiate a process of seeking a courier to deliver the item from the second business location to the first business location within a predetermined time window.

Each courier may have a mobile device, such as a smart phone. The smart phone may be loaded with a mobile application, such as the mobile application for the retail store. The courier may use their existing account with the retailer to register as a courier or undergo a separate registration process. The smart phone may be configured to determine its geographic location, for example, based on a satellite navigation system, an inertial navigation system, and the like.

The system can collect from the autonomous vehicles or the mobile devices information concerning current geographic locations of the couriers. Further, the system may broadcast a courier opportunity to the mobile devices of certain couriers or to certain autonomous vehicles which can be pre-selected based on their current geographic location (e.g., the courier opportunity can be broadcasted to only those couriers who are within a predetermined distance form the first business location or the second business location), couriers' prior performance, couriers' current route or direction, couriers' ranks, and so forth. The courier may also be provided the ability to select locations from which they can pick-up and/or make deliveries. The broadcast of available opportunities may be tailored based on the courier preferences.

In some embodiments, the courier opportunity can be initially broadcasted to some preferred couriers (e.g., couriers with a higher rank), and then, within a predetermined period, the courier opportunity can be broadcasted to the remaining couriers.

When the couriers receive the courier opportunity, for example via the mobile device, the couriers can respond by generating a claim to deliver the item. The system further collects one or more claims from the couriers and selects at least one of the couriers based on predetermined rules. For example, the system selects the courier who sent the claim first among a plurality of couriers. The system further assigns a task to the selected courier. Once assigned, the other couriers are notified that the task has been claimed. The task can be sent to the mobile device of the selected courier and include task data which can be displayed to the selected courier. The task data may include addresses of the first and second business locations, optional parking information, a time frame when the item should be picked up, a time frame when the item should be delivered, a cost of the item, a fee that could be earned by the selected courier, other conditions or requirements for the delivery, and so forth. In addition, the courier can be assigned with the task to deliver more than one item from the second business location to the first business location. Once the courier claims the item, the system associates the item with the courier's account. This may be stored as a database record associated with the courier's account. A timer for pick up or delivery may be started once the task is assigned to a courier.

Furthermore, the item can be contained in a “smart” container or certain security devices can be attached to the item to monitor a condition of the item during its delivery. For example, there can be attached certain sensors such as shipping shock detectors, impact indicators, accelerometers, location trackers, and so forth. The container may broadcast information to the server. The server may track the data from the sensors and determine a likelihood of damage to the item.

When the selected courier arrives to the second business location and picks up the item, the selected courier or business location personnel can scan the item or its portion (e.g., a bar code of the item). A kiosk may be provided for this function. The kiosk may communicate with the inventory system and the mobile application. The system determines that the item was picked up from the second business location by obtaining the scan or a corresponding message caused by the scan. The scan can include an image or video of the item. The scan can include a bar code or QR-code sent by the system to mobile device of courier. The system correlates the information from the code with the stored association of the courier and items to determine the proper courier is picking up the item. Once confirmed, the system debits a monetary or non-monetary account of the selected courier. For example, the selected courier can be debited on an amount of a retail cost of the item.

The selected courier further delivers the item to the first business location. The selected courier can use a vehicle but not necessarily. For example, the courier can use its own car, public transportation, bicycle, motorcycle, and the like. In some embodiments, the system can provide or facilitate navigation of the selected courier. For example, the system can generate or facilitate generation of a route for the selected courier to follow. The system can also assist in finding or allocating a parking space near the first and second business locations for the use by the selected courier. Moreover, the system can monitor traffic on the route and distance to travel, and adjust an anticipated delivery time respectively.

When the selected courier delivers the item to the first business location, the item can be also scanned or otherwise checked in. The kiosk may also be used for the check-in process. The scan can include a bar code or QR-code sent by the system to mobile device of courier. The code may be scanned by the kiosk to complete the delivery. In some cases the delivery destination may include an end-customer. The end-customer may use the mobile app to complete their purchase of the item. The scanning can include obtaining an image of the item. The system determines that the item was successfully delivered to the first business location, and, in response thereto, the system credits the account of the selected courier. For example, the account of the selected courier can be credited by the same amount as was previously debited when the item was picked up and, in addition, the account of the selected courier can be credited by a payment for the delivery. The payment amount can be based on a predetermined schedule and it can optionally depend on additional factors, including, but not limited to, a rank of the courier, a time when the item was picked up, a time when the item was delivered, and a condition of the item upon delivery. Thus, in some embodiments, the selected courier can be provided with a monetary or non-monetary bonus if the item was delivered ahead of scheduled time for delivery. Similarly, the credited amount can be reduced if the selected courier was late, damaged the item, and the like.

Based on the performance of the selected courier, the turnaround time, or other factors, the system can assign or update a rank of the selected courier. The rank of the couriers can be associated with courier profiles stored by the system and used later in determining when and how to broadcast courier opportunity.

The system may also use performance information to adjust bonus amounts offered and paid. For example, the system may track the compliance rate with the delivery time of high priority items. IF there is a below desired on-time performance, the system may adjust the offered bonus upwards. Similarly, a compliance time that is met at a high rate may indicate that the bonus amount may be adjusted downward without impact to customer satisfaction.

For purposes of this disclosure, the terms “retail store,” “business,” and “business location” can be used interchangeably and shall be construed to mean an organization that sells goods to one or more buyers or customers. Some examples of “business” can include, but not limited to, a retail store, a retailer, a market, a supermarket, a wholesale merchant, a distributor, a dealership, and so forth. Furthermore, for purposes of this disclosure, the terms “good” and “item” can be used interchangeably and shall be construed to mean tangible products, commodity, or merchandise that are a subject for of sale from a business to a customer. The term “inventory” shall be construed to mean a plurality of goods.

The term “courier” shall be construed to mean an autonomous vehicle, individual or organization that can deliver items from one business location to another business location. In some cases each courier may use or be associated with a mobile device. When delivering items, the couriers can optionally operate vehicles such as cars, trucks, bicycles, motorcycles, and the like. Some couriers can also use public transportation systems. The term “mobile device” shall be construed to mean any portable electronic device with a display and communication capabilities, including a mobile phone, cellular phone, mobile phone, smart phone, tablet computer, laptop computer, personal digital assistant, portable computing device, navigation system, navigator, and so forth. The term “broadcast” shall be construed to mean transmitting of information from the system to one or more mobile devices of couriers. The terms “delivery request,” “claim,” and “conformation” shall be construed to mean an electronic message or signal bearing certain information.

Various embodiments, implementations, and examples will be further described as the illustrations of the disclosure are described in detail below. While specific implementations are described, it should be understood that this is done for illustration purposes only. Other components and configurations may be used without parting from the spirit and scope of the disclosure. In addition, components, steps, and features described may be removed, added, or combined from the provided examples.

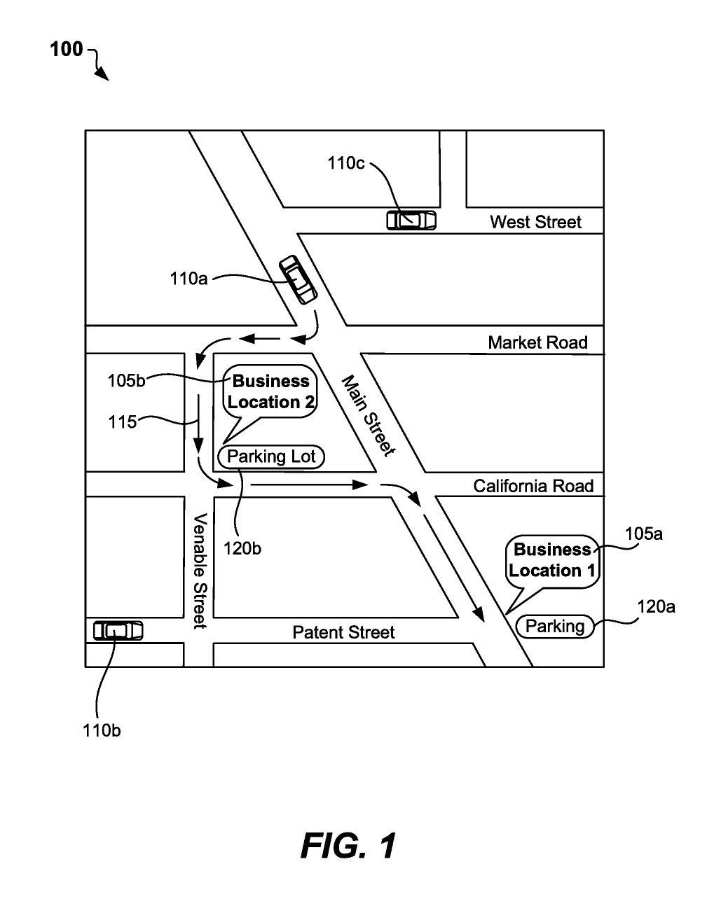

FIG. 1 illustrates a simplified geographic map 100 showing a plurality of business locations and a plurality of couriers according to one example embodiment. Geographic map 100 shown in FIG. 1 can be a displayed via a graphical user interface (GUI) of a mobile device or a computing device. For example, the GUI can be displayed to one or more couriers, personnel of business locations, or operators of a system for inventory transporting as described herein. Geographic map 100 may illustrate one or more streets, roads, avenues, highways, freeways, buildings, structures, or any other construction objects. For example, as shown in FIG. 1, geographic map 100 includes two business locations 105a and 105b. The first business location 105a can refer to a retail store. The second business location 105b can refer to another retail store, market, warehouse, or any other organization. The locations may also include end customers, such as customers that have ordered via the retails stores mobile app or web site. Geographic map 100 also displays a plurality of couriers such as couriers 110a, 110b, and 110c. References 110a through 110c may refer to current geographic locations of couriers, their vehicles, or their mobile devices. Geographic map 100 can be updated in real time.

According to various embodiments of this disclosure, when first business location 105a needs to add, replenish, or increase an inventory level of at least one inventory item, and this item is available at second business location 105b, one or more couriers 110a-110c can be searched by the system. The system may create a database of couriers. In some embodiments the couriers may be autonomous vehicles, such as drones, autonomous ground vehicles and the like. The database may associate the courier with the preferences, for example in a table structure. The table may store the courier's capabilities, availability, delivery and pick up location preferences, ranking, online/offline availability, etc. The system may correlate the delivery task with the database record to identify the available couriers. For these ends, there can be searched only those couriers 110a-110c who are located within a predetermined distance from first business location 105a or second business location 105b. Moreover, couriers 110a-110c can be searched based on other criteria, including historical data, courier ranks, courier rates, courier availability, and so forth. When one or more selected couriers 110a-110c are identified, they are informed about a courier opportunity to transport the inventory item from second business location 105b to first business location 105a.

Further, a selected or a first responded courier may assigned with a task to transport the inventory item from second business location 105b to first business location 105a. For these ends, the selected courier (e.g., courier 110a) is provided with information about the item, a time and date when it should be picked up from second business location 105b, a time and date when it should be delivered to first business location 105a, a rate or estimated fee that courier 110a earns for transporting the item, a location or address of second business location 105b, a location or address of first business location 105a, a location or address of a parking lot 120b near second business location 105b, a location or address of a parking lot 120a near first business location 105a, and optionally other information. Furthermore, a route 115 can be generated for selected courier 110a from its current location to first business location 105a through second business location 105b. The system can further facilitate navigation of courier 110a, monitor traffic, and adjust the scheduled delivery time accordingly.

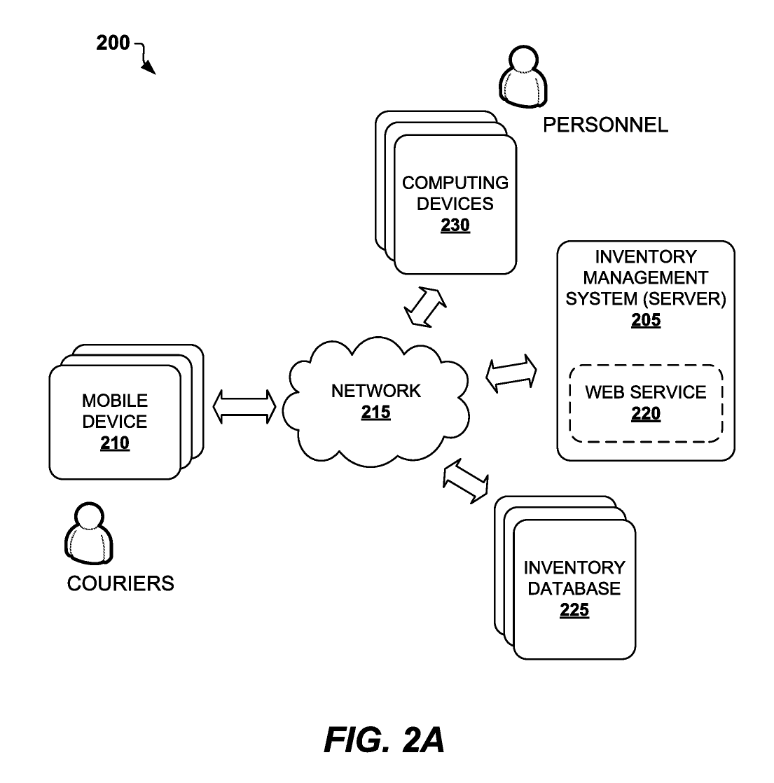

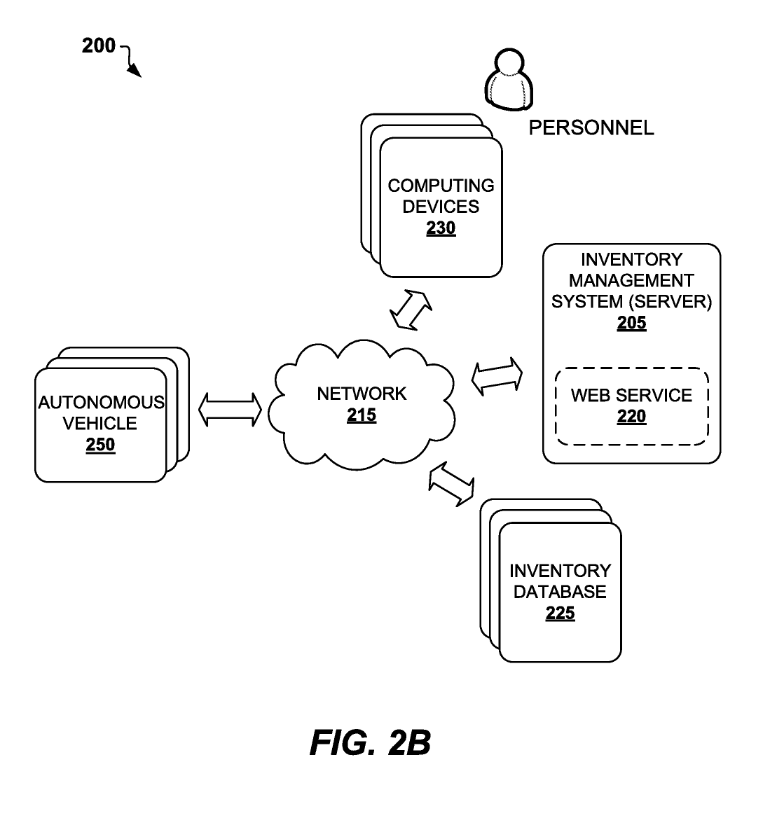

FIG. 2A illustrates an example computer system environment 200 for practicing the methods for transporting inventory according to one example embodiment. The computer system environment 100 includes an inventory management system 205 for transporting inventory, which includes a server or similar computing device. Inventory management system 205 is in communication with mobile devices 210 of couriers via a communications network 215. Communications network 215 can refer to any wired, wireless, or optical network.

Inventory management system 205 can employ a web service 220 to exchange data with mobile devices 210. In some implementations, web service 220 can additionally include or refer to a web page or an online platform. Accordingly, couriers can access or obtain data of inventory management system 205 via a browser installed on their mobile devices 210 by visiting a predetermined web site associated with inventory management system 205. Couriers can also access or obtain data from inventory management system 205 via a software (mobile) application installed on mobile devices 210 which can automatically exchange data between inventory management system 205 and mobile devices 210. For example, inventory management system 205 can receive from mobile devices 210 their identifiers, current geographic locations, and any inputs or selections made by couriers. Mobile devices 210 can receive from inventory management system 205 certain data such as broadcasted courier opportunities, details of assigned tasks to transport one or more items from one business location to another, locations of other couriers, navigation data, directions, routes, addresses, and so forth. Inventory management system 205 can maintain virtual profiles of couriers.

Computer system environment 200 also includes one or more inventory databases 225 which can be operatively connected to inventory management system 205 via communications network 215 or be incorporated into inventory management system 205. Each inventory database 225 can be associated with inventory of at least one business location. In other words, inventory databases 225 may indicate current inventory levels of one or more items. In some embodiments, inventory databases 225 can be automatically updated when items are sold or replenished. In other embodiments, inventory databases 225 can be manually updated by personnel of business locations. The personnel of business locations can use computing devices 230 to access inventory management system 205 and inventory databases 225 via communications network 215.

Inventory management system 205 can include at least one processor and at least one memory storing processor-readable instructions which, when executed by the processor, cause inventory management system 205, its components (e.g., the processor), or other elements to perform operations of the method of transporting inventory as described herein. In certain embodiments, inventory management system 205 can include a web server.

FIG. 2B illustrates an example of computer system environment 200 for practicing the methods for transporting inventory according to one example embodiment. Inventory management system 205 is in communication with autonomous vehicles via a communications network 215.

Inventory management system 205 can employ a web service 220 to exchange data with autonomous vehicles 250. Accordingly, the autonomous vehicles 250 can access or obtain data of inventory management system 205 via a web interface or API. The autonomous vehicles can also access or obtain data from inventory management system 205 via a software (mobile) application installed on the autonomous vehicles 250 which can automatically exchange data between inventory management system 205 and the autonomous vehicles 250. For example, inventory management system 205 can receive from the autonomous vehicles 250 their identifiers, current geographic locations, and capabilities, such as size or weight requirements, range, etc. The autonomous vehicles 250 can receive from inventory management system 205 certain data such as broadcasted courier opportunities, details of assigned tasks to transport one or more items from one business location to another, locations of other couriers, navigation data, directions, routes, addresses, and so forth. The autonomous vehicles 250 may provide their current availability or register with the inventory management system 205 to indicate that the autonomous vehicle 250 is available for a delivery.

Inventory management system 205 can maintain virtual profiles of the autonomous vehicles 250, as described above. When a delivery is needed, the inventory management 205 system may assign the delivery to an autonomous vehicle 250 based on matching the delivery characteristic with the profile for the autonomous vehicle. The best match may be assigned the task. In addition or in the alternative, the autonomous vehicles 250 can bid on or respond to broadcast delivery opportunities. The delivery may be assigned to the highest bidder, first to respond, etc. The other elements of FIG. 2B may be the same or similar to those described above in connection with FIG. 2A

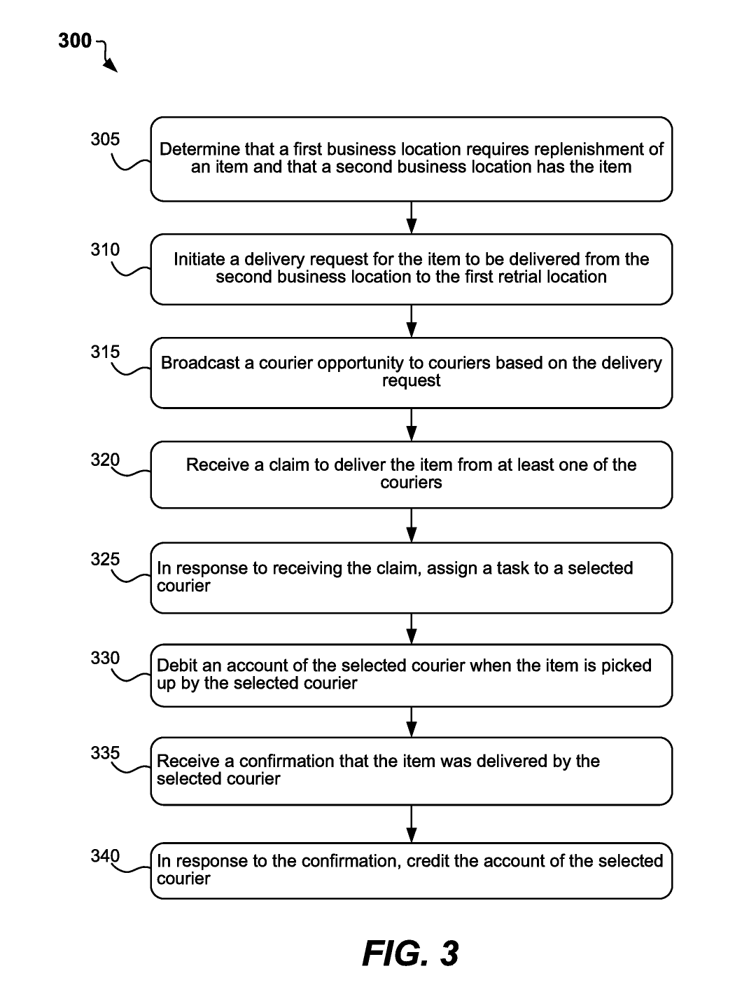

FIG. 3 illustrates a process flow diagram showing an example method 300 for transporting inventory according to one embodiment. Method 300 may be performed by processing logic that may comprise hardware (e.g., decision-making logic, dedicated logic, programmable logic, application-specific integrated circuit, and microcode), software (such as software run on a general-purpose computer system or a dedicated machine), or a combination of both. In one example embodiment, the processing logic refers to inventory management system 205 as described above. Below recited operations of method 300 may be implemented in an order different than described and shown in the figure. Moreover, method 300 may have additional operations not shown herein, but which can be evident for those skilled in the art from the present disclosure. Method 300 may also have fewer operations than outlined below and shown in FIG. 3.

Method 300 commences at operation 305 with inventory management system 205 determining that first business location 105a requires replenishment of an item and determining that second business location 105b has the item that is available for transporting to first business location 105a for replenishment of inventory. Operation 305 can be performed by monitoring one or more inventory databases 225. Alternatively, the determinations of operation 305 can be made by receipt of certain inputs of business location personnel. In some embodiments, inventory management system 205 can determine that first business location 105a requires replenishment of an item based on making predictions that an inventory level of the item is becoming lower than a predetermined threshold within a predefined time frame. The predictions can be made by monitoring one or more inventory databases 225, analyzing market demand, historical sales data, and other factors. The predictions can be made automatically using one or more approaching, including machine-learning algorithms, heuristic methods, statistics-based methods, and the like.

In addition, the system may combine multiple trips. For example, the system may identify multiple items that are to be delivered to the same store and combine those deliveries. The system may also identify multiple items that are to be delivered to locations in close proximity with each other or that have a linear relationship. The system may identify that locations A→B→C are linearly related. Based on projections, such as sales rates, consumption rates, the system may coordinate upcoming deliveries in order combine those deliveries into a single task. The delivery task for a particular item may be accelerated or delayed in order to achieve savings for a combined delivery.

At operation 310, inventory management system 205 initiates a delivery request for the item to be delivered from second business location 105b to first retail location 105a. The delivery request, when initiated, can characterize the availability for the item to be transmitted from second business location 105b to first retail location 105a. The delivery request can be confirmed, approved, or initiated by personnel of at least one of first retail location 105a and second business location 105b, but not necessarily.

At operation 315, inventory management system 205 broadcasts a courier opportunity to couriers based on the delivery request. The courier opportunity can be displayed or otherwise presented to couriers via a GUI of mobile devices 210 or sent to the autonomous vehicles. For example, the courier opportunity can be shown as a text message, email, push-up notification, a GUI of mobile application, and the like. The opportunity may also be saved to a blockchain indicating the delivery is available. The couriers, such as the autonomous vehicles can check the blockchain for delivery opportunities when the autonomous vehicles are available for deliveries. In some embodiments, inventory management system 205 can also monitor geographic locations of the couriers and pre-select only those couriers for sending the courier opportunity which are within a predetermined distance from first business location 105a or second business location 105b, or based on other factors such as couriers' rank, couriers' past performance, couriers' fee schedule, couriers' availability, and so forth.

At operation 320, inventory management system 205 receives a claim to deliver the item from at least one of the couriers. In some embodiments, inventory management system 205 receives a plurality of claims from a plurality of the couriers. In this case, inventory management system 205 selects one courier from the plurality of the couriers based on the claims or a predetermined rule. For example, inventory management system 205 can select one of the plurality of couriers based on a prior performance of the couriers, couriers' ranks, current geographic location of couriers, and other factors. In another example, inventory management system 205 can select the first responded courier.

At operation 325, inventory management system 205 generates and assigns a task to the selected courier in response to receiving the claim. In some embodiments, inventory management system 205 can also present the selected courier with a predetermined time to pick up the item from the first business location 105a. The task can be displayed on a GUI of mobile device 210 or sent to the autonomous vehicles and outline certain requirements of the delivery, including, for example, a description of the item, a quantity of the item, a time frame for picking up the item, a time frame for delivering the item, a cost of item, a fee and a bonus to be paid for successful delivery, and the like.

The pick-up and delivery time may be based on the priority of the item. The system may determine a priority for the delivery of the item. The higher the priority, the shorter the pick-up and delivery time. For high priority items, the pick-up time may be as short as a few minutes. In conjunction with the mobile app, the system may generate a code identifying the courier. The courier may scan the code at a kiosk as described above. If the courier make the delivery in the allocated time, a bonus may be applied for the high priority items. If the courier does not “scan out” the item within the predetermined time, the courier's account may be assigned a penalty. The penalty may be monetary or used as a negative in ranking the courier. The autonomous vehicle may use Wi-Fi, near filed communications, or other communications to identify itself and to locate and to pick up the proper item. The items for pick-up may be staged for pick-up at an autonomous vehicle station for the store.

At operation 330, inventory management system 205 debits an account of the selected courier when the item is picked up by the selected courier. The amount debited can be equal to a retail price of the item. Inventory management system 205 can be further configured to determine when the item was picked up. For these ends, inventory management system 205 can track a location of mobile device 210 of the selected courier. In addition, inventory management system 205 can receive an item picked-up confirmation message from computing device 203 or mobile device 210 of selected courier. The item picked-up confirmation message can be caused or generated by obtaining a scan of at least a part the item to confirm that the item was picked up for delivery by the selected courier.

Inventory management system 205 can be also configured to monitor the transportation of the item from second business location 105b to first retail location 105a. In some embodiments, inventory management system 205 may determine a delivery time for the item to be delivered by the selected courier, monitoring road traffic on or around route 115, and adjust the delivery time accordingly. The delivery time can be further presented to the personnel of at least one of second business location 105b and first retail location 105a.

Moreover, in additional embodiments, inventory management system 205 can be also configured to monitor a current geographic location of the selected courier and, based on the geographic location of the selected courier, facilitate navigation of the selected courier from second business location 105b to first retail location 105a. The inventory management system 205 may receive location data from the autonomous vehicles 250, and the autonomous vehicles may save the location data to the blockchain. Particularly, inventory management system 205 can send navigation data or directions to mobile device 110 of selected courier. In some additional embodiments, inventory management system 205 can be configured to find and allocate available parking spots for the selected courier near second business location 105b and/or first retail location 105a. Inventory management system 205 can also send to the selected courier data indicating the available parking or its location.

At operation 335, inventory management system 205 receives a confirmation that the item was delivered by the selected courier. For example, inventory management system 205 monitors when the selected courier arrives to the first business location 105a to drop off the item. The delivery of the item can be determined, for example, by generating a code for mobile device 210 of the selected courier such that personnel of first business location 105a can scan the code by its computing device 230. When the code is scanned, a delivery confirmation message caused by obtaining a scan of the code can be generated and transmitted to inventory management system 205. Moreover, in certain embodiments, the personnel of first business location 105a can make a picture of the item delivered and inspect a condition of the item. In some embodiments, the delivery confirmation message can also bear an indication of the item condition after delivery.

Similar to the pick-up of the item, the autonomous vehicle may communicate with the inventory management system at the delivery location, for example using Wi-Fi, near field communications, or other communications processes, to identify itself to deliver the item. The store may have an autonomous delivery station for delivery of the item for the store. The autonomous vehicle or the store system may generate a confirmation that the delivery has been made. In addition, the autonomous vehicle and the inventory management system can update the blockchain with the status information as tasks are completed, items picked up and delivered, location, etc.

At operation 340, inventory management system 205 credits the account of the selected courier in response to the confirmation received at operation 335. An amount credited includes the retail price of the item, a fee of the courier delivered item, and optional bonus payment if the item was delivered well before of the scheduled delivery time.

After the item is properly delivered, inventory management system 205 can also determine a performance of the selected courier. For example, inventory management system 205 can assign ranks to each courier based on their performance. The performance can depend on timing of delivery, a number of deliveries, a distance traveled, and/or other factors. Accordingly, inventory management system 205 can send an initial courier opportunity to couriers with the highest performance before the courier opportunity is sent out to other couriers. In other words, in some implementations, couriers with high ranks can receive courier opportunity earlier than other couriers.

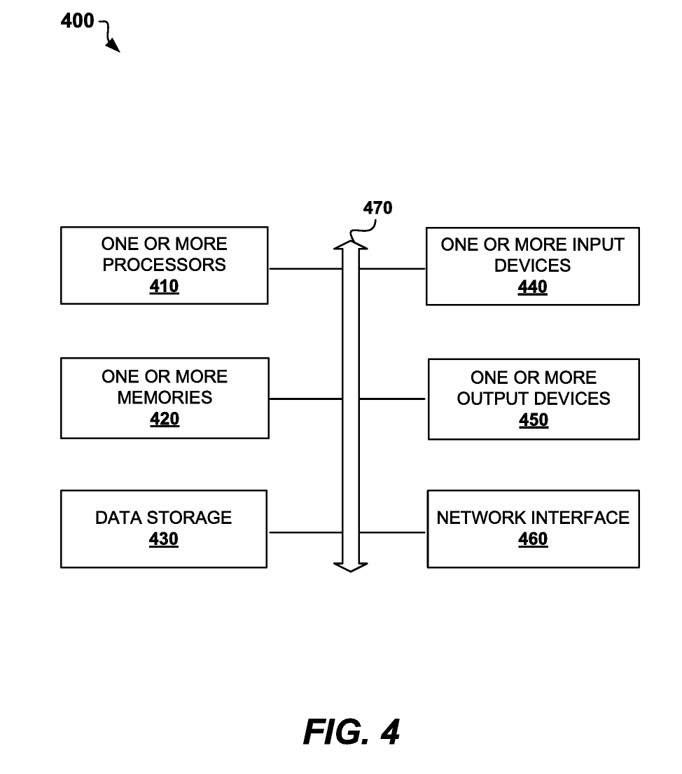

FIG. 4 illustrates an example computer system 400 which can be used to perform the methods for transporting inventory as disclosed herein. Computer system 400 can be an instance of at least one of mobile device 210, computing device 230, and inventory management system 205 shown in FIG. 2. With reference FIG. 4, computing system 400 includes one or more processors 410, one or more memories 420, one or more data storages 430, one or more input devices 440, one or more output devices 450, network interface 460, one or more optional peripheral devices, and a communication bus 470 for operatively interconnecting the above-listed elements. Processors 410 can be configured to implement functionality and/or process instructions for execution within computing system 400. For example, processors 410 may process instructions stored in memory 420 or instructions stored on data storage 430. Such instructions may include components of an operating system or software applications.

Memory 420, according to one example, is configured to store information within computing system 400 during operation. For example, memory 420 can store instructions to perform the methods for transporting inventory. Memory 420, in some example embodiments, may refer to a non-transitory computer-readable storage medium or a computer-readable storage device. In some examples, memory 420 is a temporary memory, meaning that a primary purpose of memory 420 may not be long-term storage. Memory 420 may also refer to a volatile memory, meaning that memory 420 does not maintain stored contents when memory 420 is not receiving power. Examples of volatile memories include RAM, dynamic random access memories (DRAM), static random access memories (SRAM), and other forms of volatile memories known in the art. In some examples, memory 420 is used to store program instructions for execution by processors 410. Memory 420, in one example, is used by software applications or mobile applications. Generally, software or mobile applications refer to software applications suitable for implementing at least some operations of the methods as described herein.

Data storage 430 can also include one or more transitory or non-transitory computer-readable storage media or computer-readable storage devices. For example, data storage 430 can store instructions for processor 410 to implement the methods described herein. In some embodiments, data storage 430 may be configured to store greater amounts of information than memory 420. Data storage 430 may be also configured for long-term storage of information. In some examples, data storage 430 includes non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Computing system 400 may also include one or more input devices 440. Input devices 440 may be configured to receive input from a user through tactile, audio, video, or biometric channels. Examples of input devices 440 may include a keyboard, keypad, mouse, trackball, touchscreen, touchpad, microphone, video camera, image sensor, fingerprint sensor, scanner, or any other device capable of detecting an input from a user or other source, and relaying the input to computing system 400 or components thereof.

Output devices 450 may be configured to provide output to a user through visual or auditory channels. Output devices 450 may include a video graphics adapter card, display, such as liquid crystal display (LCD) monitor, light emitting diode (LED) monitor, or organic LED monitor, sound card, speaker, lighting device, projector, or any other device capable of generating output that may be intelligible to a user. Output devices 450 may also include a touchscreen, presence-sensitive display, or other input/output capable displays known in the art.

Computing system 400 can also include network interface 460. Network interface 460 can be utilized to communicate with external devices via one or more communications networks such as data network 120 or any other wired, wireless, or optical networks. Network interface 460 may be a network interface card, such as an Ethernet card, an optical transceiver, a radio frequency transceiver, or any other type of device that can send and receive information.

An operating system of computing system 400 may control one or more functionalities of computing system 400 or components thereof. For example, the operating system may interact with the software or mobile applications and may facilitate one or more interactions between the software/mobile applications and processors 410, memory 420, data storages 430, input devices 440, output devices 450, and network interface 460. The operating system may interact with or be otherwise coupled to software applications or components thereof. In some embodiments, software or mobile applications may be included in the operating system.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, the couriers may be human or automated, and the various steps may be combined or omitted as needed.

We claim:

1. An inventory control system, comprising:
an inventory database storing inventory data and sales data for a plurality of retail stores;
a courier database storing a table of courier information associating a courier identifier with preferences;
an inventory server in communication with the inventory database and the courier database and configured to determine an item replenishment priority for items at a plurality of first retail locations based on the inventory and sales information; identify a plurality of retail locations that have the items available based on the inventory data and sales data; correlate delivery of multiple items to the first retail locations into a single task; query the courier database to identify couriers that match the delivery requirements based on a plurality of rules; assigned a task completion time based on the priority; send messages to the identified couriers regarding the task, the message including addresses of the first and second business locations, optional parking information, a time frame when the item should be picked up, a time frame when the item should be delivered, a cost of the item, and a fee; receive a response from at least one courier and assign the courier the task based on the predetermined rules; and
a plurality of kiosks disposed at the retail locations, the kiosks each including a scanner to scan a code generated by a mobile application, the code identifying the courier and items for delivery and to send a message to the server that the item has been picked up undelivered, the message including the courier identifier and the item information,
the inventory server receiving the message from the kiosks, identifying the account based on the message and adjusting the account based on the message.

2. A computer-implemented method for transporting inventory, the method comprising:
determining that a first business location requires replenishment of an item;
determining that a second business location has the item;
initiating a delivery request for the item to be delivered from the second business location to the first retail location;
broadcasting a courier opportunity to couriers based on the delivery request;
receiving a claim to deliver the item from at least one of the couriers;
in response to receiving the claim, assigning a task to a selected courier;
debiting an account of the selected courier when the item is picked up by the selected courier;
receiving a confirmation that the item was delivered by the selected courier; and
in response to the confirmation, crediting the account of the selected courier.

3. The method of claim 1, further comprising:
determining a delivery time for the item to be delivered by the selected courier; and
monitoring road traffic and adjusting the delivery time accordingly.

4. The method of claim 1, further comprising:
generating a code on a mobile device of the selected courier; and
receiving a delivery confirmation message caused by obtaining a scan of the code.

5. The method of claim 1, further comprising:
receiving an item picked-up confirmation message caused by obtaining a scan of at least a part the item to confirm that the item was picked up for delivery by the selected courier.

6. The method of claim 1, further comprising:
determining a performance of the couriers over time; and
sending an initial courier opportunity to couriers with the highest performance.

7. The method of claim 1, further comprising:
presenting the selected courier with a predetermined time to pick up the item from the first business location.

8. The method of claim 1, further comprising:
receiving a plurality of claims to deliver the item from a plurality of the couriers; and
selecting one courier from the plurality of the couriers based on the claims based on a performance of the couriers.

9. The method of claim 1, further comprising:
monitoring geographic locations the couriers; and
based on the geographic locations the couriers, selecting at least one courier from the couriers which is within a predetermined distance from the first business location.

10. The method of claim 1, wherein the first business location includes a first retail location, and the second business location includes a second retail location.

11. The method of claim 1, wherein the first business location includes a retail location, and the second business location includes a warehouse location.

12. The method of claim 1, further comprising:
monitoring a geographic location the selected courier; and
based on the geographic location the selected courier, facilitating navigating or directing the selected courier from the second business location to the first retail location.

13. The method of claim 1, further comprising:
finding available parking for the selected courier near the second business location and the first retail location; and
providing the selected courier with data indicating the available parking for the selected courier near the second business location and the first retail location.

14. A system for transporting inventory, the system comprising:
a server maintaining a web service accessible by couriers, wherein the server is configured to:
determine that a first business location requires replenishment of an item;
determine that a second business location has the item;
initiate a delivery request for the item to be delivered from the second business location to the first retail location;
broadcast a courier opportunity to couriers based on the delivery request;
receive a claim to deliver the item from at least one of the couriers;
in response to receiving the claim, assign a task to a selected courier;
debit an account of the selected courier when the item is picked up by the selected courier;
receive a confirmation that the item was delivered by the selected courier; and
in response to the confirmation, credit the account of the selected courier.

15. The system of claim 13, wherein the server is further configured to:
determine a delivery time for the item to be delivered by the selected courier; and
monitor road traffic and adjusting the delivery time accordingly.

16. The system of claim 13, wherein the server is further configured to:
generate a code on a mobile device of the selected courier; and
receive a delivery confirmation message caused by obtaining a scan of the code.

17. The system of claim 13, wherein the server is further configured to:
receive an item picked-up confirmation message caused by obtaining a scan of at least a part the item to confirm that the item was picked up for delivery by the selected courier.

18. The system of claim 13, wherein the server is further configured to:
determine a performance of the couriers over time; and
send an initial courier opportunity to couriers with the highest performance.

19. The system of claim 13, wherein the server is further configured to:
present the selected courier with a predetermined time to pick up the item from the first business location.

20. A non-transitory processor-readable medium having instructions stored thereon, which when executed by one or more processors, cause the one or more processors to implement a method for transporting inventory, the method comprising:
determining that a first business location requires replenishment of an item;
determining that a second business location has the item;
initiating a delivery request for the item to be delivered from the second business location to the first retail location;
broadcasting a courier opportunity to couriers based on the delivery request;
receiving a claim to deliver the item from at least one of the couriers;
in response to receiving the claim, assigning a task to a selected courier;
debiting an account of the selected courier when the item is picked up by the selected courier;
receiving a confirmation that the item was delivered by the selected courier; and
in response to the confirmation, crediting the account of the selected courier.
